(19) United States
(12) Patent Application Publication
(10) Pub. No.: US 2026/0005373 A1
(43) Pub. Date: Jan. 1, 2026

(54) MODULAR BATTERY SYSTEM

(71) Applicant: SCHLUMBERGER TECHNOLOGY CORPORATION, Sugar Land, TX (US)

(72) Inventor: Vikas RAKHUNDE, Katy, TX (US)

(21) Appl. No.: 19/119,809

(22) PCT Filed: Nov. 6, 2023
(86) PCT No.: PCT/US2023/036880

§ 371 Date: Apr. 10, 2025

Related U.S. Application Data
(60) Provisional application No. 63/383,146, filed on Nov. 10, 2022.

(51) Int. Cl. H01M 50/258; H01M 10/42; H01M 10/48; H01M 10/615; H01M 50/209; H01M 50/507

(52) U.S. Cl. CPC H01M 50/258; H01M 10/4257; H01M 10/48; H01M 10/615; H01M 50/209; H01M 50/507; H01M 2010/4271; H01M 2200/00

(57) ABSTRACT

A battery module includes a housing configured to receive a plurality of battery cells including at least a first battery cell and a second battery cell. The battery module also includes a plurality of busbars positioned within the housing. The busbars include four common busbars. A first of the common busbars is configured to be connected to a negative terminal of the first battery cell, and a second of the common busbars is configured to be connected to a positive terminal of the second battery cell. The busbars also include two ground bars configured to provide grounding. The busbars also include two communication bars configured to transmit communication signals.

### CROSS-REFERENCE TO RELATED APPLICATION

This application claims priority to U.S. Provisional Patent Application No. 63/383,146, which was filed on Nov. 10, 2022 and is incorporated herein by reference in its entirety.

### BACKGROUND

A subsea well refers to a well in which the wellhead and other subsea equipment (e.g., production-control equipment) are located on the seabed. The wellhead and subsea equipment use power. Some of the power (e.g., primary power) may be provided via long cables that extend from a power source at the surface. However, some of the power (e.g., backup power) may be provided via subsea batteries. The batteries may be connected to the subsea equipment via a plurality of connector cables. The connector cables are heavy, take up valuable space, are prone to tangling, and create additional locations where leaks may occur. Therefore, what is needed is a system and method for providing power to subsea equipment that remedies one or more of these issues.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A battery module is disclosed. The battery module includes a housing configured to receive a plurality of battery cells including at least a first battery cell and a second battery cell. The battery module also includes a plurality of busbars positioned within the housing. The busbars include four common busbars. A first of the common busbars is configured to be connected to a negative terminal of the first battery cell, and a second of the common busbars is configured to be connected to a positive terminal of the second battery cell. The busbars also include two ground bars configured to provide grounding. The busbars also include two communication bars configured to transmit communication signals.

A modular battery system for use in a subsea environment is also disclosed. The modular battery system includes a plurality of battery modules including at least a first battery module and a second battery module. Each of the battery modules includes a housing having a substantially circular cross-sectional shape and a central longitudinal axis. The housing is configured to receive a plurality of battery cells including at least a first battery cell and a second battery cell. The plurality of battery cells are configured to be connected in series within the housing. Each of the battery modules also includes a plurality of busbars positioned within the housing. The busbars are parallel to the central longitudinal axis. The busbars are circumferentially-offset from one another around the central longitudinal axis. The busbars include four common busbars. A first of the common busbars is configured to be connected to a negative terminal of the first battery cell, and a second of the common busbars is configured to be connected to a positive terminal of the second battery cell. The busbars also include two ground bars configured to provide grounding. The busbars also include two communication bars configured to transmit communication signals. Each of the battery modules also includes a battery management system positioned within the housing. The battery management system is configured to provide low-current protection, high-current protection, or both for the battery cells. The battery management system is configured to provide cell level voltage monitoring for the battery cells. Each of the battery modules also includes one or more heaters positioned within the housing. The one or more heaters are configured to heat the battery cells when a temperature within the housing decreases below a predetermined threshold. The modular battery system also includes an inverter configured to convert direct current from the battery modules into alternating current. The modular battery system also includes a variable frequency drive configured to vary a frequency of the alternating current. The modular battery system also includes a base unit connected to at least one of the battery modules, the inverter, the variable frequency drive, or a combination thereof. The base unit is configured provide the alternating current to subsea equipment.

A method for providing power to subsea equipment is also disclosed. The method includes placing a first plurality of battery cells into a first battery module. The method also includes placing a second plurality of battery cells into a second battery module. The method also includes connecting the first and second battery modules end-to-end to form a first array. The first battery module and the second battery module have a first rotational orientation with respect to one another when connected in parallel. The first battery module and the second battery module have a second rotational orientation with respect to one another when connected in series. The first and second rotational orientations are rotationally-offset from one another.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a conceptual, schematic view of a control system for a drilling rig, according to an embodiment.

FIG. 2 illustrates a conceptual, schematic view of the control system, according to an embodiment.

FIGS. 3A and 3B illustrate a cross-sectional side view and a cross-sectional plan view of a battery module, according to an embodiment.

FIG. 4A illustrates a cross-sectional side view of a modular battery system including an array of two battery modules that are connected in parallel, and FIGS. 4B and 4C illustrate cross-sectional plan views of the two battery modules, according to an embodiment.

FIG. 5A illustrates a cross-sectional side view of another modular battery system including two arrays and power equipment that are connected in parallel, according to an embodiment. Both arrays include two battery modules that are connected in parallel. FIGS. 5B and 5C illustrate cross-sectional plan views of two of the battery modules.

FIG. 6A illustrates a cross-sectional side view of another modular battery system including two arrays and power equipment that are connected in parallel, according to an embodiment. Both arrays include two battery modules that are connected in series. FIGS. 6B and 6C illustrate cross-sectional plan views of two of the battery modules in the first array.

FIG. 7 illustrates a cross-sectional side view of another modular battery system including two arrays and power equipment that are connected in parallel, according to an embodiment.

FIG. 8 illustrates a cross-sectional side view of another modular battery system including two arrays and power equipment (e.g., a battery supercharger) that are connected in parallel, according to an embodiment.

FIG. 9 illustrates a flowchart of a method for providing power to subsea equipment, according to an embodiment.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

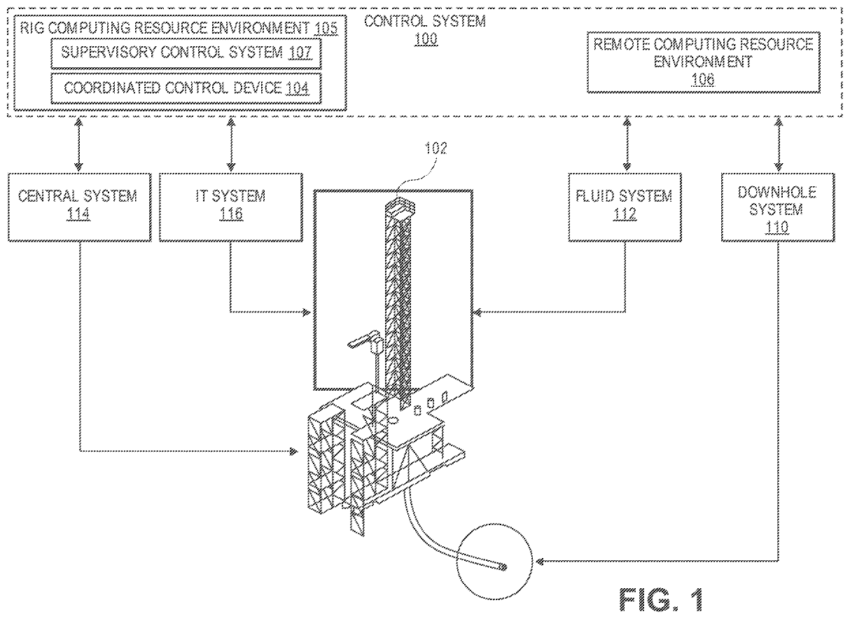

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

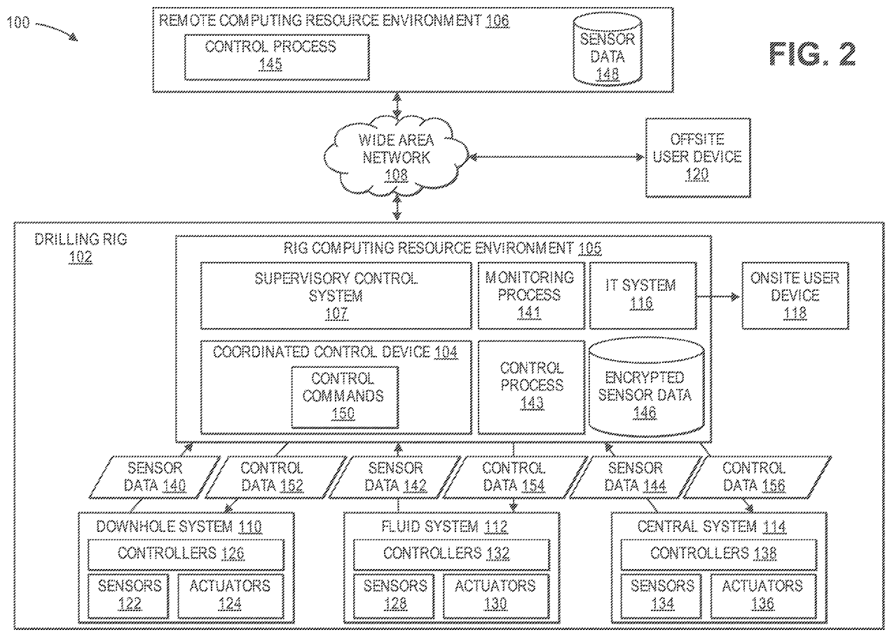

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g., tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

### Modular Battery System

The present disclosure includes a modular battery system. In one embodiment, the modular battery system may be used in subsea environments to provide power for drilling, completion, and/or production equipment. For example, the modular battery system may be used to provide power to land (also referred to as surface) equipment and/or subsea equipment. The equipment may be located at/in a drilling riser, a wellhead, and/or a wellbore. The modular battery system may be assembled, maintained, tested, monitored, and/or scaled with less effort than conventional land and/or subsea battery systems. As described below, the modular battery system may include a plurality of battery modules and/or arrays of battery modules that may be stacked end-to-end in series and/or parallel for storage and/or operation. The modular battery system reduces or eliminates connector cables. The modular battery system may be easily tested and/or charged when stored. Any land and/or subsea auxiliary equipment may share the same interface.

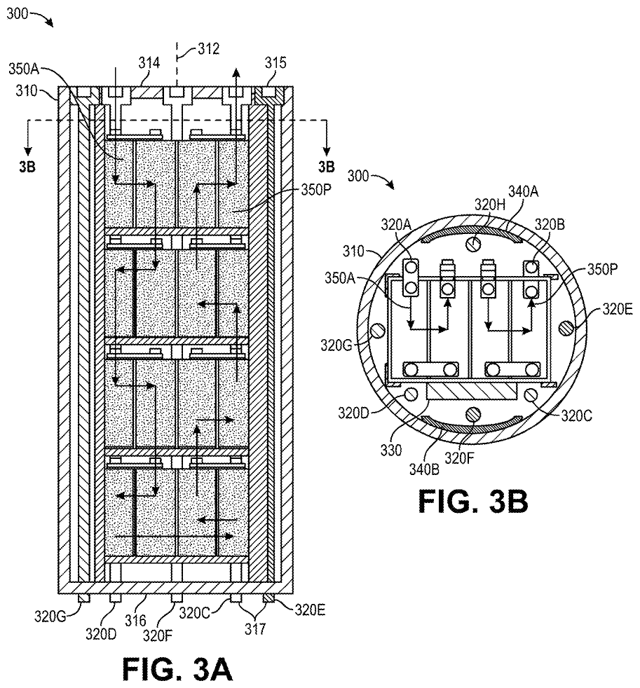

FIG. 3A illustrates a cross-sectional side view of a battery module 300, and FIG. 3B illustrates a cross-sectional plan view of the battery module 300 taken through line 3B-3B, according to an embodiment. The battery module 300 may include a housing 310. The housing 310 may be hermetically sealed to provide an internal volume into which water (e.g., sea water) cannot penetrate. In one embodiment, the internal volume may have air therein. In another embodiment, the internal volume may have a dielectric fluid therein which may or may not be compensated to hydrostatic pressure.

In the example shown, the housing 310 may be substantially cylindrical (e.g., with a substantially circular cross-sectional shape). In another example, the housing 310 may have a rectangular (e.g., square) cross-sectional shape. The housing 310 may have a central longitudinal axis 312 extending (e.g., vertically) therethrough. The housing 310 may include a first (e.g., top) cap 314 and a second (e.g., bottom) cap 316. The top cap 314 may include one or more insulated (e.g., female) conductors 315, and the bottom cap 316 may include one or more insulated (e.g., male) conductors 317.

The battery module 300 may also include one or more busbars (eight are shown: 320A-320H) that are positioned within the housing 310. The busbars 320A-320H may be substantially parallel with the axis 312. The busbars 320A-320H may be circumferentially-offset from one another around the axis 312. For example, the busbars 320A-320H may be circumferentially-offset from one another by about 45 degrees. This may allow one battery module 300 to be rotated (e.g., in increments of 45 degrees or 90 degrees) with respect to another battery module 300 to align different sets of the busbars 320A-320H to switch from/between a parallel connection and a series connection, as described below. Each of the busbars 320A-320H may be positioned between and/or connected to a corresponding set of conductors 315, 317. Thus, although five female conductors 315 and five male conductors 317 are shown, in one embodiment, there may be eight female conductors 315 and eight male conductors 317 to correspond to the eight busbars 320A-320H.

Four of the busbars 320A-320D may be common busbars that are configured to conduct electrical current (e.g., to provide power). In the embodiment shown, one of the common busbars 320A-320D (e.g., common busbar 320A) may be configured to be connected to a negative terminal of a battery, another one of the common busbars 320A-320D (e.g., common busbar 320B) may be configured to be connected to a positive terminal of another battery, and two of the common busbars 320A-320D (e.g., common busbars 320C, 320D) may remain idle (e.g., not connected to any of the batteries within the battery module 300). The common busbars 320A-320D may be circumferentially-offset from one another around the axis 312 by about 90 degrees.

Two of the busbars 320E, 320F may be ground bars that are configured to ground the battery module 300. The ground bars 320E, 320F may be circumferentially-offset from one another around the axis 312 by about 90 degrees. One of the common busbars 320A-320D (e.g., common busbar 320C) may be positioned circumferentially-between the ground bars 320E, 320F.

Two of the busbars 320G, 320H may be communication bars that are configured to transmit communication signals therethrough. The communication bars 320G, 320H may be circumferentially-offset from one another around the axis 312 by about 90 degrees. One of the common busbars 320A-320D (e.g., common busbar 320A) may be positioned circumferentially-between the communication bars 320G, 320H.

In one embodiment, one or more of the busbars 320A-320H may be identical and may be used interchangeably. For example, the busbar 320A may be used for power, grounding, and/or communication. In another embodiment, two of the four common busbars 320A-320D may be used at a time, one of the two ground bars 320E, 320F may be used at a time, and one of the two communication bars 320G, 320H may be used at a time. The remaining busbars may be idle. In yet another embodiment, the busbars 320A-320F may have a single conductor, and the busbars 320G, 320H may have a plurality of conductors because communication signals may use the plurality of conductors.

As shown in FIG. 3B, the battery module 300 may also include a battery management system (BMS) 330 that is positioned within the housing 310. The BMS 330 may be configured to provide low and/or high current protection. The BMS 330 may also provide cell level voltage monitoring. The BMS 330 may be positioned between two of the busbars 320A-320H (e.g., common busbars 320C, 320D) and/or radially-inward from one of the busbars 320A-320H (e.g., ground bar 320F). The BMS 330 may be powered by battery cells in the battery module 300, which are described below.

The battery module 300 may also include one or more heaters (two are shown: 340A, 340B) that are positioned within the housing 310. The heaters 340A, 340B may be at least partially circular in shape (e.g., to correspond to the shape of the inner surface of the housing 310). The heaters 340A, 340B may be positioned radially-outward from one or more of the busbars 320A-320H (e.g., ground bar 320F and communication bar 320H). The heaters 340A, 340B may be configured to measure the temperature within the housing 310 and/or to generate heat when the temperature is below a predetermined threshold (e.g., 5 degrees C.). The heaters 340A, 340B may be powered by the battery cells, which are described below.

The battery module 300 may be configured to receive/house one or more battery cells (sixteen are shown: 350A-350P). The battery cells 350A-350P may be connected in series within the battery module 300. In one example, each of the battery cells 350A-350P may be 3.2 volt (V) cells with about 300 amp-hours (AH). In this example, the sixteen battery cells 350A-350P connected in series may generate about 48 volts (V) and 100 amp-hours (AH). However, as will be appreciated, the voltage, current, and/or number of the battery cells 350A-350P may vary depending upon the application.

As mentioned above, one or more of the battery cells 350A-350P may be configured to be connected to one of the common busbars 320A-320D, and one or more of the battery cells 350A-350P may be configured to be connected to another/different one of the common busbars 320A-320D. More particularly, in the example shown, the negative terminal of the battery cell 350A may be connected to the common busbar 320A, and the positive terminal of the battery cell 350P may be connected to the common busbar 320B. The common busbars 320C, 320D remain idle (e.g., not connected to any of the battery cells 350A-350P) in this example. The arrows illustrate an example of the direction of the electrical current flow through the battery cells 350A-350P.

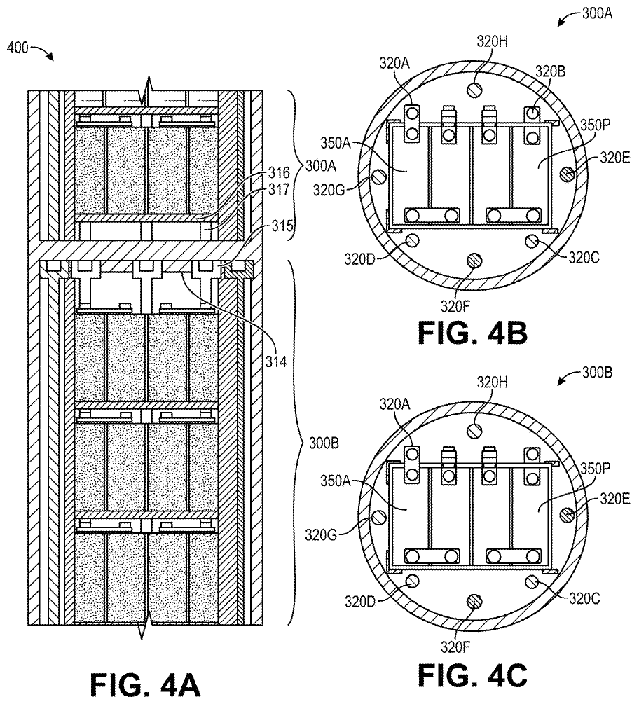

FIG. 4A illustrates a cross-sectional side view of a modular battery system 400 including an array of two battery modules 300A, 300B that are connected in parallel, and FIGS. 4B and 4C illustrate cross-sectional plan views of the two battery modules 300A, 300B, according to an embodiment. The battery modules 300A, 300B in FIGS. 4A-4C may be the same as, or different from, the battery module 300 in FIGS. 3A and 3B.

As may be seen, the battery modules 300A, 300B may be stacked end-to-end. More particularly, the male conductors 317 in the bottom cap 316 of the battery module 300A may be connected to the female conductors 315 of the top cap 314 of the battery module 300B. This connection may be made without using connector cables. When the battery modules 300A, 300B are connected in parallel (as shown in FIGS. 4A-4C), the conductors 315, 317 may be connected such that the common busbars 320A-320D in the battery modules 300A, 300B are aligned with and connected with one another, the ground busbars 320E, 320F in the battery modules 300A, 300B are aligned with and connected with one another, and the communication busbars 320G, 320H in the battery modules 300A, 300B are aligned with and connected with one another. In this example, each individual battery module 300A, 300B includes sixteen 3.2 V battery cells and generates a total of 48 V and 100 AH, and the two battery modules 300A, 300B connected in parallel may include thirty-two 3.2 V battery cells and generate a total of 48 V and 200 AH.

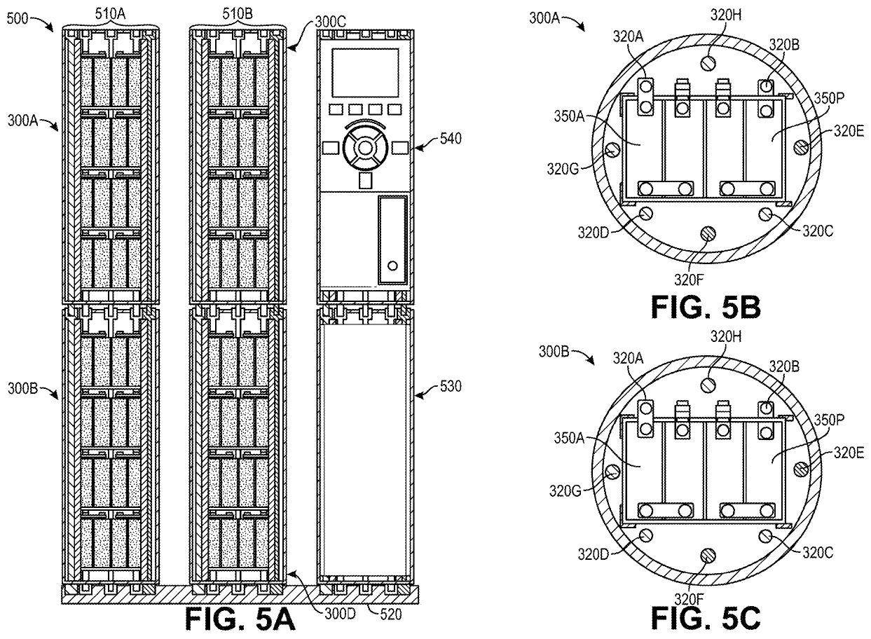

FIG. 5A illustrates a cross-sectional side view of another modular battery system 500 including two arrays 510A, 510B, according to an embodiment. The arrays 510A, 510B are arranged side-by-side and connected in parallel. Both arrays 510A, 510B include two battery modules 300A-300D that are connected in parallel. More particularly, the array 510A includes the battery modules 300A, 300B that are stacked end-to-end and connected in parallel, and the array 510B includes the battery modules 300C, 300D that are stacked end-to-end and connected in parallel. FIGS. 5B and 5C illustrate cross-sectional plan views of two of the battery modules 300A, 300B in the first array 510A. The battery modules 300C, 300D in the second array 510B may be the same as the battery modules 300A, 300B in the first array 510A. The modular battery system 500 may include sixty-four 3.2 V battery cells and generate a total of 48 V and 400 AH.

The battery system 500 may also include a base unit 520 that is configured to be connected to each array 510A, 510B. More particularly, the base unit 520 may be connected to the male conductors 317 in the bottom caps 316 of the battery modules 300B, 300D. In one embodiment, this connection may be made without using connector cables.

The battery system 500 may also include power equipment. In one example, the power equipment may be or include an inverter 530 and/or a variable frequency drive (VFD) 540. In this example, the inverter 530 and the VFD 540 may be stacked end-to-end and connected in series or parallel. The inverter 530 and/or the VFD 540 may be connected to the base unit 520. In one embodiment, the battery modules 300A-300D may provide power to the inverter 530 and/or the VFD 540. In another embodiment, the inverter 530 may be configured to convert the direct current (DC) power from the battery modules 300A-300D into alternating current (AC). The VFD 540 may be configured to vary the frequency of the alternating current.

The battery system 500 may be connected to land and/or subsea equipment such as the control system 100, the drilling rig 102, the downhole system 110, or a combination thereof. For example, the base unit 520 may be connected to (and provide power to) production-control equipment (e.g., a blow-out preventer (BOP)), a downhole tool, or a combination thereof.

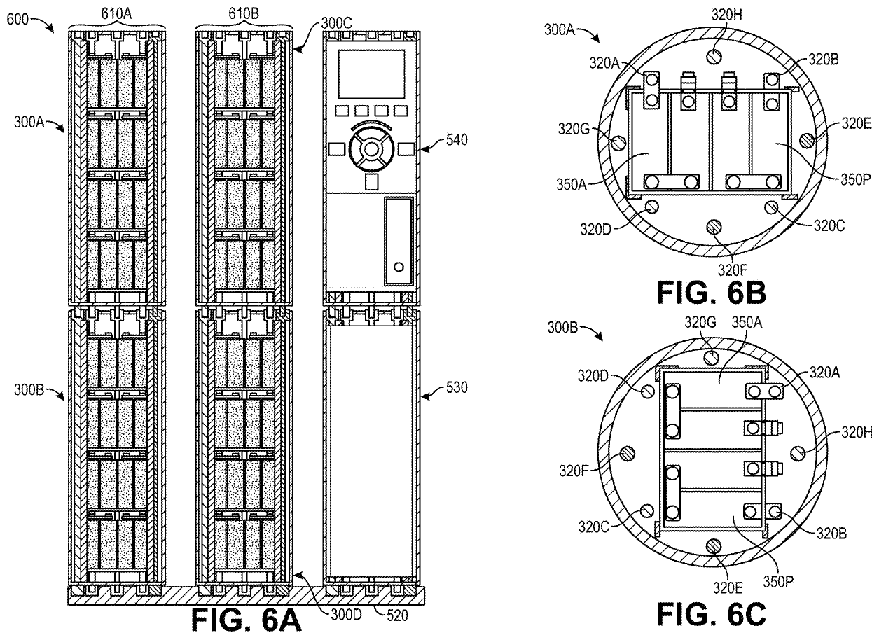

FIG. 6A illustrates a cross-sectional side view of another modular battery system 600 including two arrays 610A, 610B, according to an embodiment. The arrays 610A, 610B are arranged side-by-side and connected in parallel. Both arrays 610A, 610B include two battery modules 300A-300D that are connected in series. More particularly, the array 610A includes the battery modules 300A, 300B that are stacked end-to-end and connected in series, and the array 610B includes the battery modules 300C, 300D that are stacked end-to-end and connected in series. FIGS. 6B and 6C illustrate cross-sectional plan views of two of the battery modules 300A, 300B in the first array 610A. The battery modules 300C, 300D in the second array 610B may be the same as the battery modules 300A, 300B in the first array 610A. The modular battery system 600 may include sixty-four 3.2 V battery cells and generate a total of 96 V and 200 AH.

As mentioned above, the battery modules 300A, 300B may be stacked end-to-end and connected in series. More particularly, the male conductors 317 in the bottom cap 316 of the battery module 300A may be connected to the female conductors 315 of the top cap 314 of the battery module 300B. The battery modules 300A, 300B may have a first rotational orientation with respect to one another when connected in parallel (FIGS. 5A-5C) and a second rotational orientation with respect to one another when connected in series (FIGS. 6A-6C). One of the battery modules (e.g., battery module 300B) may be rotated (e.g., 90 degrees) with respect to the other battery module (e.g., battery module 300A) to switch from/between the first rotational orientation (e.g., parallel connection) and the second rotational orientation (e.g., series connection). As shown in FIGS. 6A-6C, the battery module 300B has been rotated 90 degrees with respect to the battery module 300A. The rotation may occur before or after the conductors 315, 317 are connected.

As a result, the common busbar 320A of the battery module 300A, which is connected to the negative terminal of the battery cell 350A in the battery module 300A, may be aligned with and/or connected to the common busbar 320D of the battery module 300B, which is idle (i.e., not connected to a battery cell within the battery module 300B). In addition, the common busbar 320B of the battery module 300A, which is connected to the positive terminal of the battery cell 350P in the battery module 300A, may be aligned with and/or connected to the common busbar 320A of the battery module 300B, which is connected to the negative terminal of the battery cell 350A in the battery module 300B. The common busbar 320C of the battery module 300A, which is idle, may be aligned with and/or connected to the common busbar 320B of the battery module 300B, which is connected to the positive terminal of the battery cell 350P in the battery module 300B. The common busbar 320D of the battery module 300A, which is idle, may be aligned with and/or connected to the common busbar 320C of the battery module 300B, which is idle.

In addition, the ground busbar 320E of the of the battery module 300A may be aligned with and/or connected to the communication busbar 320H of the battery module 300B. Thus, these busbars 320E, 320H may not be used for grounding or communication. The ground busbar 320F of the of the battery module 300A may be aligned with and/or connected to the ground busbar 320E of the battery module 300B. Thus, these busbars 320F, 320E may be used for grounding the battery system 600. The communication busbar 320G of the battery module 300A may be aligned with and/or connected to the ground busbar 320F of the battery module 300B. Thus, these busbars 320G, 320F may not be used for grounding or communication. The communication busbar 320H of the battery module 300A may be aligned with and/or connected to the communication busbar 320G of the battery module 300B. Thus, these busbars 320F, 320E may be used for communication.

The battery system 600 may also include the base unit 520, the inverter 530, and/or the VFD 540. The battery system 600 may be connected to land and/or subsea equipment such as the control system 100, the drilling rig 102, the downhole system 110, or a combination thereof. For example, the base unit 520 may be connected to (and provide power to) production-control equipment (e.g., a blow-out preventer (BOP)), a downhole tool, or a combination thereof.

Although not shown, in one embodiment, one array 610A may include two modules 300A, 300B connected in series, and the other array 610B may include two modules 300C, 300D connected in parallel.

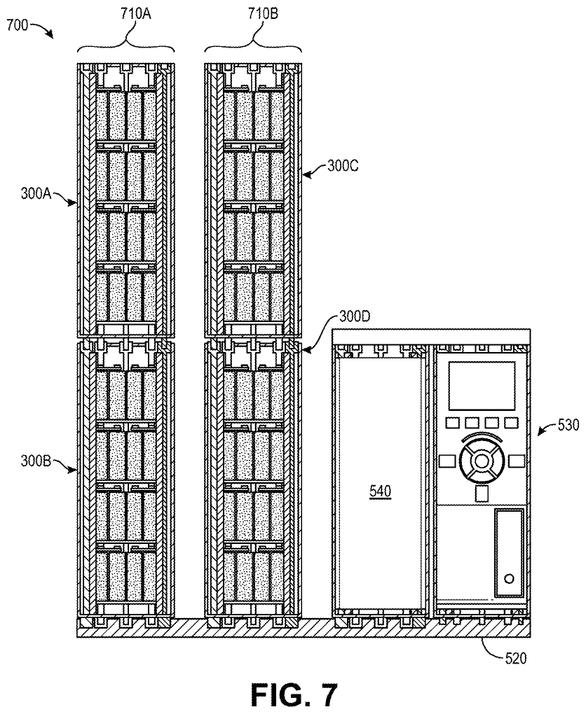

FIG. 7 illustrates a cross-sectional side view of another modular battery system 700 including two arrays 710A, 710B and power equipment that are connected in parallel, according to an embodiment. The power equipment includes the inverter 530 and the VFD 540, which are connected in parallel. In contrast to FIGS. 5A and 6A where the inverter 530 and the VFD 540 are stacked end-to-end, in FIG. 7, the inverter 530 and the VFD 540 are side-by-side and connected in parallel to the base unit 520.

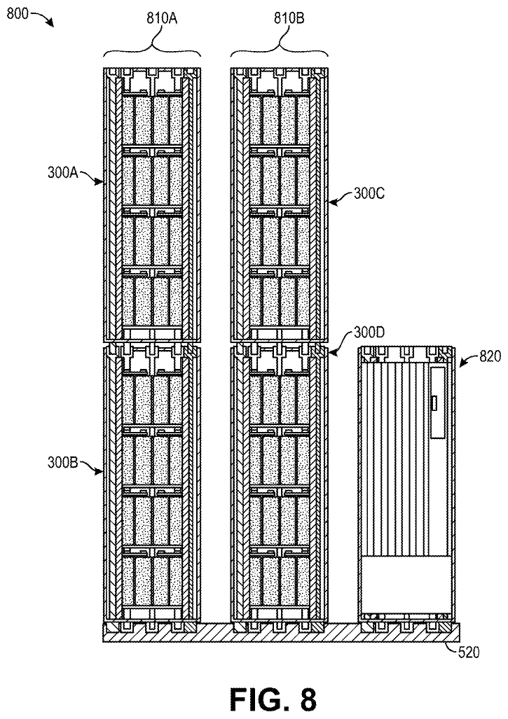

FIG. 8 illustrates a cross-sectional side view of another modular battery system 800 including two arrays 810A, 810B and power equipment (e.g., a battery charger 820) that are connected in parallel, according to an embodiment. The battery charger 820 may be connected to the base unit 520 and configured to charge one or more of the battery modules 300A-300D.

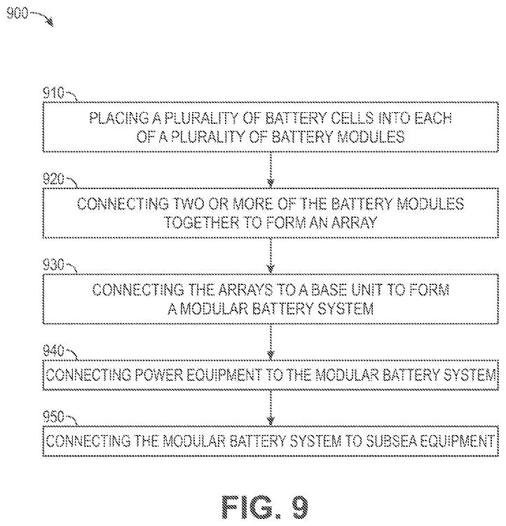

FIG. 9 illustrates a flowchart of a method 900 for providing power to land and/or subsea equipment, according to an embodiment. More particularly, the method 900 may be for assembling one or more battery modules 300A-300D to provide power to a wellhead and other equipment (e.g., production-control equipment) located on a seabed and/or in a wellbore. An illustrative order of the method 900 is provided below; however, one or more portions of the method 900 may be performed in a different order, combined, repeated, or omitted.

The method 900 may include placing a plurality of battery cells 350A-350P into each of the battery modules 300A-300D, as at 910. As mentioned above, the battery cells 350A-350P may be connected in series within each battery module 300A-300D.

The method 900 may also include connecting two or more of the battery modules 300A-300D together to form one or more arrays, as at 920. As mentioned above, the battery modules 300A, 300B may be stacked end-to-end, and the battery modules 300C, 300D may be stacked end-to-end. More particularly, the male conductors 317 on the bottom cap 316 of one of the battery modules 300A may be connected with the female conductors 315 on the top cap 314 of another of the battery modules 300B to form a first array 510A-810A. The male conductors 317 on the bottom cap 316 of one of the battery modules 300C may be connected with the female conductors 315 on the top cap 314 of another of the battery modules 300D to form a second array 510B-810B. In one embodiment, the battery modules 300A, 300B may be connected in parallel, as described above with respect to FIGS. 5A-5C. In another embodiment, the battery modules 300A, 300B may be connected in series, as described above with respect to FIGS. 6A-6C. Connecting the battery modules 300A, 300B in series may include rotating one of the battery modules 300B with respect to the other battery module 300A before or after the connection is made.

The method 900 may also include connecting the arrays 510A-810A, 510B-810B to the base unit 520 to form a modular battery system 400-800, as at 930. The arrays 510A-810A, 510B-810B may be arranged side-by-side and connected to the base unit 520 in parallel.

The method 900 may also include connecting power equipment to the modular battery system 400-800, as at 940. For example, the power equipment may be connected to the base unit 520. In the examples above, the power equipment may be or include the inverter 530, the VFD 540, and/or the charger 820. As mentioned above, the power equipment may be stacked end-to-end or arranged side-by-side. The power equipment may be connected in series or parallel.

The method 900 may also include connecting the modular battery system 400-800 to land and/or subsea equipment, as at 950. In one embodiment, the modular battery system 400-800 (e.g., the base unit 520) may be connected to land and/or subsea equipment such as the control system 100, the drilling rig 102, the downhole system 110, or a combination thereof. For example, the base unit 520 may be connected to (and provide power to) production-control equipment (e.g., a blow-out preventer (BOP)), a downhole tool, or a combination thereof.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A battery module, comprising:
a housing configured to receive a plurality of battery cells including at least a first battery cell and a second battery cell; and
a plurality of busbars positioned within the housing, wherein the busbars comprise:
four common busbars, wherein a first of the common busbars is configured to be connected to a negative terminal of the first battery cell, wherein a second of the common busbars is configured to be connected to a positive terminal of the second battery cell;
two ground bars configured to provide grounding; and
two communication bars configured to transmit communication signals.

2. The battery module of claim 1, wherein the battery module is configured to be connected end-to-end with a second battery module, wherein the battery module and the second battery module have a first rotational orientation with respect to one another when connected in parallel, wherein the battery module and the second battery module have a second rotational orientation with respect to one another when connected in series, and wherein the first and second rotational orientations are rotationally-offset from one another.

3. The battery module of claim 1, wherein the housing has a central longitudinal axis, and wherein the busbars are parallel to the central longitudinal axis.

4. The battery module of claim 3, wherein the busbars are circumferentially-offset from one another around the central longitudinal axis.

5. The battery module of claim 3, wherein the four common busbars are circumferentially-offset from one another around the central longitudinal axis by about 90 degrees, wherein the two ground bars are circumferentially-offset from one another around the central longitudinal axis by about 90 degrees, and wherein the two communication bars are circumferentially-offset from one another around the central longitudinal axis by about 90 degrees.

6. The battery module of claim 3, wherein each of the two ground bars is positioned circumferentially-between two of the four common busbars, and wherein each of the two communication bars is positioned circumferentially-between two of the four common busbars.

7. The battery module of claim 1, further comprising one or more heaters positioned within the housing, wherein the one or more heaters are configured to heat the battery cells when a temperature within the housing decreases below a predetermined threshold in a subsea environment.

8. The battery module of claim 7, wherein one of the one or more heaters comprises a substantially circular outer surface that corresponds to a substantially circular inner surface of the housing.

9. The battery module of claim 7, further comprising a battery management system positioned within the housing, wherein the battery management system is configured to provide low-current protection, high-current protection, or both for the battery cells, and wherein the battery management system is configured to provide cell level voltage monitoring for the battery cells.

10. The battery module of claim 9, wherein at least one of the four common busbars, the two ground bars, the two communication bars, or a combination thereof is positioned radially-between the battery management system and the one or more heaters.

11. A modular battery system for use in a subsea environment, the modular battery system comprising:
a plurality of battery modules including at least a first battery module and a second battery module, wherein each of the battery modules comprises:
a housing having a substantially circular cross-sectional shape and a central longitudinal axis, wherein the housing is configured to receive a plurality of battery cells including at least a first battery cell and a second battery cell, wherein the plurality of battery cells are configured to be connected in series within the housing;
a plurality of busbars positioned within the housing, wherein the busbars are parallel to the central longitudinal axis, wherein the busbars are circumferentially-offset from one another around the central longitudinal axis, and wherein the busbars comprise:
four common busbars, wherein a first of the common busbars is configured to be connected to a negative terminal of the first battery cell, wherein a second of the common busbars is configured to be connected to a positive terminal of the second battery cell;
two ground bars configured to provide grounding; and
two communication bars configured to transmit communication signals;
a battery management system positioned within the housing, wherein the battery management system is configured to provide low-current protection, high-current protection, or both for the battery cells, and wherein the battery management system is configured to provide cell level voltage monitoring for the battery cells; and
one or more heaters positioned within the housing, wherein the one or more heaters are configured to heat the battery cells when a temperature within the housing decreases below a predetermined threshold;
an inverter configured to convert direct current from the battery modules into alternating current;
a variable frequency drive configured to vary a frequency of the alternating current; and
a base unit connected to at least one of the battery modules, the inverter, the variable frequency drive, or a combination thereof, wherein the base unit is configured provide the alternating current to subsea equipment.

12. The modular battery system of claim 11, wherein the first and second battery modules are configured to be connected end-to-end, wherein the first and second battery modules have a first rotational orientation with respect to one another when connected in parallel, wherein the first and second battery modules have a second rotational orientation with respect to one another when connected in series, and wherein the first and second rotational orientations are rotationally-offset from one another.

13. The modular battery system of claim 11, wherein the plurality of battery modules also comprises a third battery module and a fourth battery module, wherein the first and second battery modules are stacked end-to-end and connected in series or parallel to form a first array, wherein the third and fourth battery modules are stacked end-to-end and connected in series or parallel to form a second array, and wherein the first and second arrays are connected to the base unit in parallel.

14. The modular battery system of claim 11, wherein the first and second battery modules are stacked end-to-end and connected in parallel such that:
the first common busbar of the first battery module is aligned with and connected with the first common busbar of the second battery module,
the second common busbar of the first battery module is aligned with and connected with the second common busbar of the second battery module,
the two ground bars of the first battery module are aligned with and connected with the two ground bars of the second battery module, and
the two communication bars of the first battery module are aligned with and connected with the two communication bars of the second battery module.

15. The modular battery system of claim 11, wherein the first and second battery modules are stacked end-to-end and connected in series such that:
the first common busbar of the second battery module is aligned with and connected with the second common busbar of the first battery module,
the second common busbar of the second battery module is aligned with and connected with a third common busbar of the first battery module, wherein the third common busbar is not connected to any of the battery cells in the first battery module,
a first of the ground bars of the second battery module is aligned with and connected with a second of the ground bars of the first battery module,
a second of the ground bars of the second battery module is aligned with and connected with a first of the communication bars of the first battery module,
a first of the communication bars of the second battery module is aligned with and connected with a second of the communication bars of the first battery module, and
a second of the communication bars of the second battery module is aligned with and connected with a first of the ground bars of the first battery module.

16. A method for providing power to subsea equipment, the method comprising:
placing a first plurality of battery cells into a first battery module;
placing a second plurality of battery cells into a second battery module; and
connecting the first and second battery modules end-to-end to form a first array, wherein the first battery module and the second battery module have a first rotational orientation with respect to one another when connected in parallel, wherein the first battery module and the second battery module have a second rotational orientation with respect to one another when connected in series, and wherein the first and second rotational orientations are rotationally-offset from one another.

17. The method of claim 16, wherein the first and second battery modules each comprise four common busbars, wherein a first of the four common busbars in the first battery module is configured to be connected to a negative terminal of a first battery in the first battery module, wherein a second of the four common busbars in the first battery module is configured to be connected to a positive terminal of a second battery in the first battery module, wherein a first of the four common busbars in the second battery module is configured to be connected to a negative terminal of a first battery in the second battery module, and wherein a second of the four common busbars in the second battery module is configured to be connected to a positive terminal of a second battery in the second battery module.

18. The method of claim 17, wherein the first common busbar in the second battery module is aligned with the first common busbar in the first battery module when the first and second battery modules are connected in parallel, and wherein the first common busbar in the second battery module is aligned with the second common busbar in the first battery module when the first and second battery modules are connected in series.

19. The method of claim 16, further comprising:
placing a third plurality of battery cells into a third battery module;
placing a fourth plurality of battery cells into a fourth battery module;
connecting the third and fourth battery modules end-to-end to form a second array; and
connecting the first and second arrays to a base unit in parallel.

20. The method of claim 19, further comprising:
connecting an inverter to the base unit, wherein the inverter is configured to convert direct current from the first and second arrays to alternating current;
connecting a variable frequency drive to the base unit, wherein the variable frequency drive is configured to vary a frequency of the alternating current; and
connecting the base unit to subsea equipment to power the subsea equipment with the alternating current.
